(19) United States
(12) Patent Application Publication
(10) Pub. No.: US 2021/0024687 A1
(43) Pub. Date: Jan. 28, 2021

(54) AROMATIC LIQUID CRYSTAL POLYESTER, AROMATIC LIQUID CRYSTAL POLYESTER COMPOSITION, AND MOLDED ARTICLE

(71) Applicant: SUMITOMO CHEMICAL COMPANY, LIMITED, Tokyo (JP)

(72) Inventors: Shinji OHTOMO, Tsukuba-shi (JP); Masanobu MATSUBARA, Ichihara-shi (JP)

(21) Appl. No.: 16/982,632

(22) PCT Filed: Mar. 25, 2019
(86) PCT No.: PCT/JP2019/012455

§ 371 Date: Sep. 21, 2020

(30) Foreign Application Priority Data
Mar. 27, 2018 (JP) 2018-059883

(51) Int. Cl. C08G 63/60; C08G 63/78; C08K 7/14; C09K 19/38

(52) U.S. Cl. CPC C08G 63/605; C08G 63/78; C08G 2120/00; C09K 19/3809; C09K 2323/035; C08K 7/14

(57) ABSTRACT

An aromatic liquid crystal polyester containing repeating structural units represented by formulas (A1), (B), (C) and (D) shown below.

—O—Ar1—CO— (A1)

—CO—Ar2—CO— (B)

—O—Ar3—O— (C)

—O—Ar4—O— (D)

(In the formulas, Ar1 represents a 2,6-naphthalene group, Art represents at least one group selected from the group consisting of a 2,6-naphthalenediyl group, 1,4-phe vlene group, 1,3-phenvIene group and 4,4′-biphenylene group, Ar3 represents at least one group selected from the group consisting of a 2, mphthalenediyl group, 1,6-naphthalenediyl group and 1,5-naphthalenediyl group, Ar4 represents at least one group selected from the group consisting of a 2,6-naphthalenediyl group, 1,4-phenylene group, 1,3-phenylene group and 4,4′-hiphenylene group, and each of the groups represented by Ar1, Ar3 or Ar4 may have a halogen atom, an alkyl group of 1 to 10 carbon atoms Of alt aryl group of 6 to 20 carbon atoms as a substituent.)

### TECHNICAL FIELD

The present invention relates to an aromatic liquid crystal olyester, and aromatic liquid crystal polyester composition, and a molded article.

Priority is claimed on Japanese Patent Application No. 2018-059883 filed Mar. 27, 2018, the contents of which are incorporated herein by reference.

### BACKGROUND ART

Liquid crystal polyesters are used as formation materials for various electronic component structures. In recent years, electronic components have continued to exhibit increased functional integration and reduced size. In order to adapt to these types of circumstances,liquid crystal polyesters that have excellent dimensional stability and high strength are required.

For example, Patent Document 1 discloses a liquid crystal polyester having a structural unit derived from 2,7-dihydroxynaphthalene.

### CITATION LIST

### Patent Document

Patent Document 1: JP S60-38426-A

### SUMMARY OF THE INVENTION

### Problems to be Solved by the Invention

The liquid crystal polyester disclosed in Patent Document 1 still leaves significant room for improvement from the viewpoints of improving the dimensional stability and increasing the strength of obtained molded articles.

The present invention has been developed in light of these circumstances, and has the object of providing an aromatic liquid crystal polyester and an aromatic liquid crystal polyester composition that uses this aromatic liquid crystal polyester which are capable of molding molded articles having excellent dimensional stability and high strength.

### Means to Solve the Problems

In other words, the present invention includes the following aspects.

[1] An aromatic liquid crystal polyester containing repeating structural units represented by formulas (A1), (B), (C) and (D) shown below.

—O—Ar1—CO— (A1)

—CO—Ar2—CO— (B)

—O—Ar3—O— (C)

—O—Ar4—O— (D)

(In the formulas, Ar1 represents a 2,6-naphthalenediyi group, Ar2 represents at least one group selected from the group consisting of a 2,6-naphthalenediyl group, 1,4-phenylene group, 1,3-phenylene group and 4,4′-biphenylene group, Ar3 represents at least one group selected from the group consisting of a 2,7-naphthalenediyl group, 1,6-naphthalenediyl group and 1,5-naphthalenediyl group, and Ar4 represents at least one group selected from the group consisting of a 2,6-naphthalenediyl group, 1,4-phenylene group, 1,3-phenylene group and 4,4′-biphenylene group. Each of the groups represented by Ar1, Ar2, Ar3 or Ar4 may have a halogen atom, an alkyl group of 1 to 10 carbon atoms or an aryl group of 6 to 20 carbon atoms as a substituent.)
[2] The aromatic liquid crystal polyester according to [1], composed solely of repeating structural units represented by formulas (A1), (B), (C) and (D).
[3] The aromatic liquid crystal polyester according to [1] or [2], wherein the olar fraction of the repeating structural unit represented by formula (A1) is at least 30 mol % but not more than 80 mol % relative to the total molar amount of all the repeating units, the molar fraction of the repeating structural unit represented by formula (13) is at least 10 mol % but not more than 35 mol % relative to the total molar amount of all the repeating units, the molar fraction of the repeating structural unit represented by formula (C) is at least 0.1 mol % but not more than 20 mol % relative to the total molar amount of all the repeating units, and the molar fraction of the repeating structural unit represented by formula (D) is at least 9.9 mol % but not more than 34.9 mol % relative to the total molar amount of all the repeating units.
[4] The aromatic liquid crystal polyester according to [1], further containing a repeating structural unit represented by formula (A2) shown below.

(A2) —O—Ar10—CO—

On the formula, Ar10 represents a 1,4-phenylene group. The group represented by Ar10 may have a halogen atom, an alkyl group of 1 to 10 carbon atoms or an aryl group of 6 to 20 carbon atoms as a substituent.)
[5] The aromatic liquid crystal polyester according to any one of [1] to [4], having a weight average molecular weight of at least 20,000, and a flow start temperature of at least 200° C. but not more than 370° C.
[6] The aromatic: crystal polyester according to any one of [1] to [5], wherein the repeating structural unit represented by formula (D) is one or both of a repeating structural unit derived from 4,4′-biphenol and a repeating structural unit derived from hydroquinone.
[7] An aromatic liquid crystal polyester composition comprising the aromatic liquid crystal polyester according to any one of [1] to [6] and glass fiber, wherein the amount of the glass fiber, relative to the total mass of the aromatic crystal polyester composition, is at least 5% by mass but not more than 60% by mass,
[8] A molded article obtained by injection molding of the aromatic liquid crystal polyester ccording to any one of [1] to [6].
[9] A molded article obtained by injection molding of the aromatic liquid crystal polyester composition according to [7].

### Effects of the Invention

The present invention can provide an aromatic liquid crystal polyester and an aromatic liquid crystal polyester composition comprising this aromatic liquid crystal polyester which are capable of molding molded articles having excellent dimensional stability and high strength.

### EMBODIMENTS FOR CARRYING OUT THE INVENTION

### <Aromatic Liquid Crystalline, Polyester>

One embodiment of the present invention is an aromatic liquid crystal polyester characterized by containing r acing stru ural units represented by formulas (A1), (B), (C) and (D).

—O—Ar1—CO— (A1)

—CO—Ar2—CO— (B)

—O—Ar3—O— (C)

—O—Ar4—O— (D)

(In the formulas, Ar1 represents 2,6-naphthalenediyl group, Ar2 represents at least one group selected from the group consisting of a 2,6-naphthalenediyl group, 1,4-phenylene group, 1,3-phenylene group and 4,4′-biphenylene group, Ar3 represents at least one group selected from the group consisting of a 2,7-naphthalenediyl group, 1,6-naphthalenediyl group and 1,5-naphthalenediyl group, and Ar4 represents at least one group selected from the group consisting of a 2,6-naphthalenediyl group, 1,4-phenylene group, 1,3-phenylene group and 4,4′-biphenylene group. Each of the groups represented by Ar1, Ar2, Ar3 or Ar4 may have a halogen atom, an alkyl group of 1 to 10 carbon atoms or an aryl group of 6 to 20 carbon atoms as a substituent.)

In this enaboditnent, by including repeating structural units represented by formulas (A1), (B), (C) and (D) as essential structural units, an aromatic liquid crystal polyester capable otmolding a molded article having excellent dimensional stability and high strength can be provided.

The aromatic liquid crystal polyester of an embodiment of the present invention may also contain a repeating structural unit represented by formula (A2) shown below as an optional component.

—O—Ar10—CO— (A2)

(In the formula, Ar10 represents a 1,4-phenylene group. The group represented by Ar10 may have a halogen atom, an alkyl group of 1 to 10 carbon atoms or an aryl group of 6 to 20 carbon atoms as a substituent.)

A repeating unit derived from 2-hydroxy-6-naphthoic acid is preferable as the repeating unit (A1).

In this description, “derived” means the raw material monomer undergoes a change in the chemical structure due to polymerization, with no other structural change occurring.

A repeating unit derived from p-hydroxybenzoic acid is preferable as the repeating unit (A2).

A repeating unit derived from terephthalic acid, a repeating unit derived from isophthalic acid, a repeating unit derived from 2,6-naphthalenedicarboxylic acid, and a repeating unit derived from diphenyl ether-4,4′-dicarboxylic acid are preferable as the repeating unit (B).

Ar3 in the formula for the repeating unit (C) is at least one group selected from the group consisting of a 2,7-naphthalenediyl group, 1,6-naphthalenediyl group and 1,5-naphthalenediyl group, is preferably at least one group selected from the group consisting of a 2,7-naphthalenediyl group and a 1,6-naphthalenediyl group, and is more preferably a 2,7-naphthalenediyl group.

The repeating unit (C) is preferably at least one unit selected from the group consisting of a repeating unit derived from 2,7-naphthalenediol (also called 2,7-dihydroxynaphthalene), a repeating unit derived from 1,6-naphthalenediol (also called 1,6-dihydroxynaphthalene) and a repeating unit derived from 1,5-naphthalenediol (also called 1,5-dihydroxynaphthalene), is preferably at least one unit selected from the group consisting of a repeating unit derived from 2,7-naphthalenediol and a repeating unit derived from 1,6-naphthalenediol, and is more preferably a repeating unit derived from 2,7-naphthalenediol. Including a repeating unit (C) having these types of naphthalenediyl groups or diol structures facilitates a reduction in the melt viscosity of the aromatic liquid crystal polyester, and is consequently preferable. Further, by including a repeating unit (D) having a naphthalene skeleton, the dimensional stability of a molded article molded using the aromatic liquid crystal polyester improves, and the strength can be enhanced.

A repeating unit derived from 4,4′-biphenol and a repeating unit derived from hydroquinone are preferable as the repeating unit (D). Further, a single repeating unit (D) may be used alone, or a combination of two or more repeating units may be used. In other words, one or both of a repeating unit derived from 4,4′-biphenol and a repeating unit derived from hydroquinone are preferable as the repeating unit (D).

Examples of the abovementioned halogen atom include a fluorine atom, a chlorine atom, a bromine atom and an iodine atom.

Specific examples of the abovementioned alkyl group include a methyl group, ethyl group, n-propyl group, isopropyl group, n-butyl group, isobutyl group, s-butyl group, t-butyl group, n-he yl group, 2-ethylhexyl group, n-octyl group and n-decyl group.

Specific examples of the abovementioned aryl group include a phenyl group, o-tolyl group, m-toyl, group, p-tolyl group, 1-naphthyl group and 2-naphthyl group.

In the group rented by Ar1, Ar10, Ar2 or Ar4, in those cases where at least one hydrogen atom is substituted with an abovementioned substituent, the number of substituents in each group represented by Ar1, Ar10, Ar2, Ar3 or Ar4 is preferably either I or 2. Further, the number of substituents in each group represented by Ar1, Ar10, Ar2, Ar3 or Ar4 is more preferably 1.

In embodiments of the present invention, the, polyester may be an aromatic liquid crystal polyester composed solely of the repeating units (A1), (A2), (B), (C) and (D), or may be an aromatic liquid crystal polyester composed solely of the repeating units (A1), (B), (C) and (D).

From the viewpoints of enabling a molded article to be imparted with excellent dimensional stabilityr and superior strength, an aromatic liquid crystal polyester composed solely of the repeating units (A1), (B), (C) and (D) is preferable.

In an embodiment of the present invention, the molar fraction of the repeating structural unit represented by formula (A1), relative to the total molar amount of all the repeating units (namely, the total molar amount of all the repeating units that constitute the aromatic liquid crystal polyester), is preferably at least 30 mol % but not more than 80 mol %, more preferably at least 40 mol %; but not more than 70 mol %, and particularly preferably at least 50 mol % but not more than 65 mol %.

In an embodiment of the present invention, the molar fraction of the repeating structural unit represented by formula (B), relative to the total molar amount of all the repeating units (namely, the total molar amount of all the repeating units that constitute the aromatic liquid crystal polyester), is preferably at least 10 mol % but not more than 35 mol %, more preferably at least 15 mol % but not more than 30 mol %, and particularly preferably at least 17 mol % but not more than 25 mol %.

In an embodiment of the present invention, the molar fraction of the repeating structural unit represented by formula (C), relative to the total molar amount of all the repeating units (namely, the total molar amount of all the repeating units that constitute the aromatic liquid crystal polyester), is preferably at least 0.1 mol % but not more than 20 mol %, more preferably at least 0.5 mol % but not more than 15 mol %, and particularly preferably at least 0.8 mol % but not more than 12 mol %.

In an embodiment of the present invention, the molar fraction of the repeating structural unit represented by formula (D), relative to the total molar amount of all the repeating units (namely, the total molar amount of all the repeating units that constitute the aromatic liquid crystal polyester), is preferably at least 9.9 mol % but not more than 34.9 mol %, more preferably at least 12 mote but not more than 30 mol %, and particularly preferably at least 14 mol % but not more than 25 mol %.

In an embodiment of the present invention, in those cases where the polyester contains a repeating structural unit represented by formula (A2), the molar fraction of that repeating structural unit, relative to the total molar amount of all the repeating units (namely, the total molar amount of all the repeating units that constitute the aromatic liquid crystal polyester), is preferably at least 1 mol % but not more than 50 mol %, more preferably at least 5 mol % but not more than 40 mol %, and particularly preferably at least 8 mol % but not more than 30 mol %.

However, the total molar amount of the repeating units (A1), (A2), (B), (C) and (D) does not exceed 100 mol %.

The aromatic liquid crystal polyester of an embodiment of the present invention has a weight average molecular weight that is preferably at least 5,000 but not more than 400,000, and more preferably at least 20,000 but not more than 400,000.

The weight average molecular weight is, for example, a value obtained by averaging two measured values (polystyrene-equivalent values) obtained by conducting two gel permeation chromatography (GPC) analyses.

The aromatic liquid crystal polyester of an embodiment of the present invention is preferably produced by conducting a melt polymerization of the raw material monomers corresponding with the repeating units that constitute the aromatic liquid crystal polyester, and subjecting the thus obtained polymer (hereinafter sometimes referred to as a “prepolymer”) to a solid phase polymerization.

The melt polymerization may be conducted in the presence of a catalyst, and examples of this catalyst include metal compounds such as magnesium acetate, stannous acetate, tetrabutyl titanate, lead acetate, sodium acetate, potassium acetate and antimony trioxide, and nitrogen-containing heterocyclic compounds such as 4-(dimethylamino)pyridine and 1-methylimidazole, with the use of a nitrogen-containing heterocyclic compound being preferable.

The aromatic liquid crystal polyester of an embodiment of the present invention preferably has a flow start temperature of at least 200° C. but not higher than 370° C. In one aspect, the flow start temperature may be at least 297° C. but not higher than 333° C.

Here, the flow start temperatureis also called the flow temperature or fluidity temperature. The flow start temperature is measured using a capillary rheometer to melt the liquid crystal polyester while the temperature is raised at a rate of 4° C./minute under a loading of 9.8 MPa (100 kgf/cm²), and is the temperature at which the viscosity reaches 4,800 Pa·s (48,000 poise) when the liquid crystalline polyester is extruded from a nozzle having an internal diameter of 1 mm and a length of 10 mm. The flow start temperature acts as an indicator of the molecular weight of the liquid crystalline polyester (see “Liquid Crystal Polymers—Synthesis⋅Molding⋅Applications”, edited by Naoyuki Koide, page 95, published by⁻CMC Publishing Co., Ltd., Jun. 5, 1987).

In the aromatic liquid crystal polyester of an embodiment of the present invention, among the various options, by combining the repeating structural unit (A1) and the repeating structural unit (C), the strength of the produced molded articles can be increased.

<Aromatic Liquid Crystal Polyester Composition>One embodiment of the present invention is an aromatic liquid crystal polyester composition comprising the aromatic liquid crystal polyester of an embodiment described above and glass fiber.

In the aromatic liquid crystal polyester composition of this embodiment, amount of the glass fiber, relative to the total mass of the aromatic liquid crystal polyester composition, is at least 5% by mass but not more than 60% by mass, and is preferably at least 10% by mass but not more than 50% by mass, and particularly at least 15% by mass but not more than 45% by mass.

in one aspect, the glass fiber has an average fiber length of 2 μm to 4 mm, and preferably an average fiber diameter of 0.1 μm to 50 μm.

Examples of the glass fiber include fibers produced by various methods, such as chopped strand glass fiber and milled strand glass fiber.

Further, in the aromatic liquid crystal polyester composition of this embodiment the amount of the aromatic liquid crystal polyester, relative to the total mass of the aromatic liquid crystal polyester composition, is preferably at least 40% by mass but not more than 100% by mass.

In one aspect, the aromatic liquid crystal polyester composition of an embodiment of the present invention may be an aromatic liquid crystal polyester composition composed solely of the aromatic liquid crystal polyester of an embodiment described above and glass fiber.

In another aspect, the aromatic liquid crystal polyester composition of an embodiment of the present invention may be an aromatic liquid crystal polyester composition that comprises the aromatic liquid crystal polyester of an embodiment described above, glass fiber, and other components as required (for example, inorganic fillers such as glass beads, hollow glass spheres, glass powder, mica, talc, clay, silica, alumina, potassium titanate, wollastonite, calcium carbonate (including heavy, light and colloidal varieties), magnesium carbonate, basic magnesium carbonate, sodium sulfate, calcium sulfate, barium sulfate, calcium sulfite, aluminum hydroxide, magnesium hydroxide, calcium hydroxide, calcium silicate, silica sand, silica rock, quartz, titanium oxide, zinc oxide, iron oxide, graphite, molybdenum, asbestos, silica-alumina fiber, alumina fiber, gypsum fiber, carbon fiber, carbon black, white carbon, diatomaceous earth, bentonite, sericite, shirasu and graphite; and metal-based or non-metal-based whiskers such as potassium titanate whiskers, alumina whiskers, aluminum borate whiskers, silicon carbide whiskers and silicon nitride whiskers).

The amount of these other components, relative to the total mass of the aromatic liquid crystal polyester composition is preferably from 0.01 to 50% by mass.

### <Molded Article>

One embodiment of the present invention is a molded article obtained by injection molding of the aromatic liquid crystal polyester or aromatic liquid crystal polyester composition of an embodiment described above.

Examples of molded articles of the aromatic liquid crystal polyester or aromatic liquid crystal polyester composition include bobbins such as optical pickup bobbins and transformer bobbins; relay components such as relay cases, relay bases, relay sprues and relay armatures; connectors such as RIMM, DDR, CPU sockets, S/O, DIMM, Board to Board connectors, EPC connectors and card connectors; reflectors such as lamp reflectors and LED reflectors; holders such as lamp holders and heater holders; diaphragms such as speaker diaphragms; separation claws such as separation claws for copiers and separation claws for printers; camera module components; switch components; motor components; sensor components; hard disk drive components; tableware such as ovenware; vehicle components; aircraft components; sealing members such as sealing members for semiconductor elements and sealing members for coils; films; and fibers and the like.

The molded article of this embodiment has high strength, and has a tensile strength of at least 130 MPa but not more than 220 MPa, and preferably at least 155 MPa but not more than 200 MPa. In another aspect, the tensile strength may be at least 137 MPa but not more than 182 MPa.

Further, the molded article of this embodiment has a flexural strength of at least 170 MPa but not more than 240 MPa, and preferably at least 190 MPa but not more than 220 MPa. In another aspect, the flexural strength may be at least 176 MPa but not more than 206 MPa.

Moreover, the molded article of this embodiment has excellent dimensional stability, and in terms of the molding shrinkage factor, has an MD shrinkage of at least 0.01 but not more than 0.20, and preferably at least 0.05 but not more than 0.15. In another aspect, the MD shrinkage may be at least 0.09 but not more than 0.19.

Furthermore, the ID shrinkage of the molded article of this embodiment is at least 0.10 but not more than 1.45, and is preferably at least 0.30 but not more than 1.10. In another aspect, the TD shrinkage may be at least 0.99 but not more than 1.45.

In this description, the “dimensional stability” means the degree of dimensional change of the injection molded article removed from the mold relative to the mold.

The tensile strength of the molded article can be determined, for example, using the method described below in the section entitled <Measurement of Tensile Strength>.

The flexural strength of the molded article can be determined, for example, using the method described below in the section entitled <Measurement of Flexural Strength>.

In this description, “MD” means the direction of resin flow during the injection molding, and “TD” means the direction perpendicular to the direction of resin flow during the injection molding.

The MD shrinkage and TD shrinkage of the molded article can be determined, for example, using the method described below in the section entitled <Measurement of Molding Shrinkage Factors>.

A molded article molded using the same forming material as the test pieces used in the <Measurement of Tensile Strength>, <Measurement of Flexural Strength>and <Measurement of Molding Shrinkage Factors> described in the following examples has the same characteristics as the characteristics of the test pieces.

<Method for Producing Molded Article using Aromatic Liquid Crystal Polyester or Aromatic Liquid Crystal Polyester Composition>

A method for producing a molded article using the aromatic liquid crystal polyester or aromatic liquid crystal polyester composition of an embodiment described above is described below.

In the method for producing a molded article according to this embodiment, a conventional melt molding method, and preferably a molding method such as injection molding, extrusion molding, compression molding, blow molding or vacuum molding can be used.

Further, film production such as film molding using a T-die or inflation molding, or melt spinning can also be used. Injection molding is particularly preferable in terms of being able to be used for molded bodies of various shapes, and enabling superior productivity to be achieved. Injection molding is described below.

One example of a favorable injection molding method is a method in which pellets of the aromatic liquid crystal polyester or pellets of the aromatic liquid crystal polyester composition are melted by heating at a temperature at least as high as the flow start temperature of the pellets, but not higher than the flow start temperature +100° C., and then performing inject molding of the melted pellets in a mold set to a temperature of at least 50° C.

In one aspect, an aromatic liquid crystal polyester that represents one embodiment of the present invention is either:

an aromatic liquid crystal polyester composed solely of a repeating unit derived from 2-hydroxy-6-naphthoic acid (in an amount of at least 50 mol % but not more than 65 mol % relative to the total molar amount of all the repeating units), a repeating unit derived from 4,4′-biphenol (in an amount of at least 14 mol % but not more than 25 mol % relative to the total molar amount of all the repeating structural units), a repeating structural unit derived from 2,7-dihydroxynaphthalene an amount of at least 0.8 mol % but not more than 12 mol % relative to the total molar amount of all the repeating units), and a repeating unit derived from terephthalic acid (in an amount of at least 17 mol % but not more than 25 mol % relative to the total molar amount of all the repeating units), or an aromatic liquid crystal polyester composed solely of a repeating unit derived from 2-hydroxy-6-naphthoic acid (in an amount of at least 50 mol % but not more than 65 mol % relative to the total molar amount of all the repeating units), a repeating unit derived from 4,4′-biphenol (in an amount of at least 14 mol % but not more than 25 mol % relative to the total moarl amount of all the repeating structural units), a repeating structural unit derived from 1,6-dihydroxynaphthalene (in an amount of at least 0.8 mol % but not more than 12 mol % relative to the total molar amount of all the repeating units), and a repeating unit derived from terephthalic acid (in an amount of at least 17 mol % but not more than 25 mol % relative to the total molar amount of all the repeating units).

Moreover, the aromatic liquid crystal polyester may have a flow start temperature of at least 290° C. but not higher than 350° C., or at least 297° C. but not higher than 333° C.

In addition, the aromatic liquid crystal polyester may be an aromatic liquid crystal polyester which, when molded to form a molded article by injection molding, has characteristics including:

a tensile strength for the molded article of 137 to 182 MPa,

a flexural strength for the molded article of 176 to 206 MPa,

an MD shrinkage for the molded article of 0.09 to 0.19%, and

a TD shrinkage for the molded article of 0.99 to 1.45%.

A molded article that represents one embodiment of the present invention is a molded article formed by injection molding of the aromatic liquid crystal polyester described above, and has characteristics including:

a tensile strength of 137 to 182 MPa,

a flexural strength of 176 to 206 MPa,

an MD shrinkage of 0.09 to 0.19%, and

a TD shrinkage of 0.99 to 1.45%.

### EXAMPLES

Next, the present invention is described in further detail using a series of examples.

### Example 1

A reactor fitted with a stirrer, a torque meter, a nitrogen gas inlet tube, a thermometer and a reflux condenser was charged with 1,129.1 g (6.0 mol) of 2-hydroxy-6-naphthoic acid, 353.8 g (1.9 mol) of 4,4′-biphenol, 16.0 g (0.1 mol) of 2,7-dihydroxynaphthalene, 332.3 g (2.0 mol) of terephthalic acid, 1,123.0 g (11 mol) of acetic anhydride and 0.06 g of N-methylimidazole. Following thorough flushing of the inside of the reactor with nitrogen gas, the temperature was increased to 142° C. over a period of 60 minutes under a stream of nitrogen gas, and the contents were then refluxed for 1 hour with the temperature maintained. Subsequently, the temperature was increased to 305° C. over a period of 4 hours and 30 minutes, while the distilled by-product acetic acid and unreacted acetic anhydride were removed by distillation, and deeming the point where an increase in torque was noticed as the end of the reaction, the contents were then extracted. The obtained solid fraction was cooled to room temperature (23° C.), ground in a coarse grinder, and was then heated, under a nitrogen atmosphere, from room temperature to 230° C. over a period of 1.5 hours and then from 230° C. to 310° C. over a period of 10 hours and 15 minutes, and then held at 310° C. for 5 hours, thereby causing a polymerization reaction to proceed in the solid phase to obtain a powdered aromatic liquid crystal polyester.

### Example 2

A reactor fitted with a stirrer, a torque eter, a nitrogen gas inlet tube, a. thermometer and a reflux condenser was charged with 1,129.1 g (6.0 mol) of 2-hydroxy-6-naphthoic acid, 335.2 g (1.8 mol) of 4,4′-biphenol, 32.0 g (0.2 mol) of 2,7-dihydroxynaphthalene, 332.3 g (2.0 mol) of terephthalic acid, 1,123.0 g (11 mol) of acetic anhydride and 0.06 g of N-methylimidazole. Following thorough flushing of the inside of the reactor with nitrogen gas, the temperature was increased to 142° C. over a period of 60 minutes under a stream of nitrogen gas, and the contents were then refluxed for 1 hour with the temperature maintained. Subsequently, the temperature was increased to 305° C. over a period of 4 hours and 30 minutes, while the distilled by-product acetic acid and unreacted acetic anhydride were removed by distillation, and deeming the point where an increase in torque was noticed as the end of the reaction, the contents were then extracted. The obtained solid fraction was cooled to room temperature (23° C.), ground in a coarse grinder, and was then heated, under a nitrogen atmosphere, from room temperature to 230° C. over a period of 1.5 hours and then from 230° C. to 310° C. over a period of 10 hours and 15 minutes, and then held at 310° C. for 5 hours, thereby causing a polymerization reaction to proceed in the solid phase to obtain a powdered aromatic liquid crystal polyester.

### Example 3

A reactor fitted with a stirrer, a torque meter, a nitrogen gas inlet tube, a thermometer and a reflux condenser was charged with 1,129.1 g (6.0 mol) of 2-hydroxy-6-naphthoic acid, 279.3 g (1.5 mol) of 4,4′-biphenol, 80.1 g (0.5 mol) of 2,7-dihydroxynaphthalene, 332.3 g (2.0 mol) of terephthalic acid, 1,123.0 g (11 mol) of acetic anhydride and 0.06 g of N-methylimidazole. Following thorough flushing of the inside of the reactor with nitrogen gas, the temperature was increased to 142° C. over a period of 60 minutes under a stream of nitrogen gas, and the contents were then refluxed for 1 hour with the temperature maintained. Subsequently, the temperature was increased to 305° C. over a period of 4 hours and 30 minutes, while the distilled by-product acetic acid and unreacted acetic anhydride were removed by distillation, and deeming the point where an increase in torque was noticed as the end of the reaction, the contents were then extracted. The obtained solid fraction was cooled to room temperature (23° C.), ground in a coarse grinder, and was then heated, under a nitrogen atmosphere, from room temperature to 230° C. over a period of 1.5 hours and then from 230° C. to 310° C. over a period of 10 hours and 15 minutes, and then held at 310° C. for 5 hours, thereby causing a polymerization reaction to proceed in the solid phase to obtain a powdered aromatic liquid crystal polyester.

### Comparative Example 1

A reactor fitted with a stirrer, a torque meter, a nitrogen gas inlet tube, a thermometer and a reflux condenser was charged with 828.7 g (6.0 mol) of 4-hydroxybenzoic acid, 372.4 g (2.0 mol) of 4,4′-biphenol, 249.2 g (1.5 mol) of terephthalic acid, 83.1 g (0.5 mol) of isophthalic acid, 1,123.0 g (11 mol) of acetic anhydride and 0.06 g of N-methylimidazole. Following thorough flushing of the inside of the reactor with nitrogen gas, the temperature was increased to 142° C. over a period of 60 minutes under a stream of nitrogen gas, and the contents were then refluxed for 1 hour with the temperature maintained. Subsequently, the temperature was increased to 305° C. over a period of 4 hours and 30 minutes, while the distilled by-product acetic acid and unreacted acetic anhydride were removed by distillation, and deeming the point where an increase in torque was noticed as the end of the reaction, the contents were then extracted. The obtained solid fraction was cooled to room temperature (23° C.), ground in a coarse grinder, and was then heated, under a nitrogen atmosphere, from room temperature to 230° C. over a period of 1.5 hours and then from 230° C. to 285° C. over a. period of 7 hours, and then held at 285° C. for 5 hours, thereby causing a polymerization reaction to proceed in the solid phase to obtain a powdered aromatic liquid crystal polyester.

### Comparative Example 2

A reactor fitted with a stirrer, o meter, a nitrogen gas inlet tube, a thermometer and ux condenser was charged with 828.7 g (6.0 mol) of 4-hydroxybenzoic acid 335.2 g (1.8 mol) of 4,4′-biphenol, 32.0 g (0.2 mol) of 2,7-dihydroxynaphthalene, 332.3 g (2.0 mol) of terephthalic acid, 1,123.0 g (11 mol) of acetic anhydride and 0.06 g of N-methylimidazole. Following thorough flushing of the inside of the reactor with nitrogen gas, the temperature was increased to 142° C. over a period of 60 minutes under a stream of nitrogen gas, and the contents were then refluxed for 1 hour with the temperature maintained. Subsequently, the temperature was increased to 305° C. over a period of 4 hours and 30 minutes, while the distilled by-product acetic acid and unreacted acetic anhydride were removed by distillation, and deeming the point where an increase in torque was noticed as the end of the reaction, the contents were then extracted. The obtained solid fraction was cooled to room temperature (23° C.), ground in a coarse grinder, and was then heated, under a nitrogen atmosphere, from room temperature to 230° C. over a period of 1.5 hours and then from 230° C. to 290° C. over a period of 7 hours and 40 minutes, and then held at 290° C. for 5 hours,thereby causing a polymerization reaction to proceed in the solid phase to obtain a powdered aromatic liquid crystal polyester.

### Comparative Example 3

A reactor fitted with a stirrer, a torque meter, nitrogen gas inlet tube, a thermometer and a reflux condenser was charged with 828.7 g (6.0 mol) of 4-hydroxybenzoic acid. 219.3 g (1.5 mol) of 4,4′-biphenol, 80.1 g (0.5 mol) of 2,7-dihydroxynaphthalene, 332.3 g (2.0 mol) of terephthalic acid, 1,123.0 g (11 mol) of acetic anhydride and 0.06 g of N-methylimidazole. Following thorough flushing of the inside of the reactor with nitrogen gas, the temperature was increased to 142° C. over a period of 60 minutes under a stream of nitrogen gas, and the contents were then refluxed for 1 hour with the temperature maintained. Subsequently, the temperature was increased to 305° C. over a period of 4 hours and 30 minutes, while the distilled by-product acetic acid and unreacted acetic anhydride were removed by distillation, and deeming the point where an increase in torque was noticed as the end of the reaction, the contents were then extracted. The obtained solid fraction was cooled to room temperature (23° C.), ground in a coarse grinder, and was then heated, under a nitrogen atmosphere, from room temperature to 230° C. over a period of 1.5 hours and then from 230° C. to 290° C. over a period of 7 hours and 40 minutes, and then held at 290° C. for 5 hours, thereby causing a polymerization reaction to proceed in the solid phase to obtain a powdered aromatic liquid crystal polyester.

### Comparative Example 4

A reactor fitted with a stirrer, a torque meter, a nitrogen gas inlet tube, a thermometer and a reflux condenser was charged with 1,129.1 g (6.0 mol) of 2-hydroxy-6-naphthoic acid, 372.4 g (2.0 mol) of 4,4′-biphenol, 332.3 g (2.0 mol) of terephthalic acid, 1,123.0 g (11 mol) of acetic anhydride and 0.06 g of N-methylimidazole. Following thorough flushing of the inside of the reactor with nitrogen gas, the temperature was increased to 142° C. over a period of 60 minutes under a stream of nitrogen gas, and the contents were then refluxed for 1 hour with the temperature maintained. Subsequently, the temperature was increased to 305° C. over a period of 4 hours and 30 minutes, while the distilled by-product acetic acid and unreacted acetic anhydride were removed by distillation, and deeming the point where an increase in torque was noticed as the end of the reaction, the contents were then extracted. The obtained solid fraction was cooled to room temperature (23° C.), ground in a coarse grinder, and was then heated, under a nitrogen atmosphere, from room temperature to 230° C. over a period of 1.5 hours and then from 230° C. to 310° C. over a period of 10 hours and 15 minutes, and then held at 310° C. for 5 hours, thereby causing a polymerization reaction to proceed in the solid phase to obtain a powdered aromatic liquid crystal polyester.

### Example 4

A reactor fitted with a stirrer, a torque meter, a nitrogen gas inlet tube, a thermometer and a reflux condenser was charged with 1,129.1 g (6.0 mol) of 2-hydroxy-6-naphthoic acid, 353.8 g (1.9 mol) of 4,4′-biphenol, 16.0 g (0.1 mol) of 1,6-dihydroxynaphthalene, 332.3 g (2.0 mol) of terephthalic acid, 1,123.0 g (11 mol) of acetic anhydride and 0.06 g of N-methylimidazole. Following thorough flushing of the inside of the reactor with nitrogen gas, the temperature was increased to 142° C. over a period of 60 minutes under a stream of nitrogen gas, and the contents were then refluxed for 1 hour with the temperature maintained. Subsequently, the temperature was increased to 305° C. over a period of 4 hours and 30 minutes, while the distilled by-product acetic acid and unreacted acetic anhydride were removed by distillation, and deeming the point where an increase in torque was noticed as the end of the reaction, the contents were then extracted. The obtained solid fraction was cooled to room temperature (23° C.), ground in a coarse grinder, and was then heated, under a nitrogen atmosphere, from room temperature to 250° C. over a period of 1.5 hours and then from 250° C. to 300° C. over a period of 6 hours and 30 minutes, and then held at 300° C. for 5 hours, thereby causing a polymerization reaction to proceed in the solid phase to obtain a powdered aromatic liquid crystal polyester.

### Example 5

A reactor fitted with a stirrer, torque meter, a nitrogen gas inlet tube, a thermometer and a reflux condenser was charged with 1,129.1 g (6.0 mol) of 2-hydroxy-6-naphthoic acid, 335.2 g (1.8 mol) of 4,4′-biphenol, 32.0 g (0.2 mol) of 1,6-dihydroxynaphthakne, 332.3 g (2.0 mol) of terephthalic acid, 1,123.0 g (11 mol) of acetic anhydride and 0.06 g of N-methylimidazole. Following thorough flushing of the inside of the reactor with nitrogen gas, the temperature was increased to 142° C. over a period of 60 minutes under a stream of nitrogen gas, and the contents were then refluxed for 1 hour with the temperature maintained. Subsequently, the temperature was increased to 305° C. over a period of 4 hours and 30 minutes, while the distilled by-product acetic acid and unreacted acetic anhydride were removed by distillation, and deeming the point where an increase in torque was noticed as the end of the reaction, the contents were then extracted. The obtained solid fraction was cooled to room temperature (23° C.), ground in a coarse cinder, and was then heated, under a nitrogen atmosphere, from room temperature to 250° C. over a period of 1.5 hours and then from 250° C. to 300° C. over a period of 6 hours and 30 minutes, and then held at 300° C. for 5 hours, thereby causing a polymerization reaction to proceed in the olid phase to obtain a powdered aromatic liquid crystal polyester.

### Example 6

A reactor fitted ith a stirrer, torque meter, a nitrogen gas inlet tube, a 6-naphthoic acid, 279.3 g (1.5 mol) of 4,4′-biphenol, 80.1 g (0.5 mol) of 1,6-dihydroxynaphthalene, 332.3 g (2.0 mol) of terephthalic acid, 1,123.0 g (11 mol) of acetic anhydride and 0.06 g of N-methylimidazole. Following thorough flushing of the inside of the reactor with nitrogen gas, the temperature was increased to 142° C. over a period of 60 minutes under a stream of nitrogen gas, and the contents were then refluxed for 1 hour with the temperature maintained. Subsequently, the temperature was increased to 305° C. over a period of 4 hours and 30 minutes, while the distilled by-product acetic acid and unreacted acetic anhydride were removed by distillation, and deeming the point where an increase in torque was noticed as the end of the reaction, the contents were then extracted. The obtained solid fraction was cooled to room temperature (23° C.), ground in a coarse grinder, and was then heated, under a nitrogen atmosphere, from room temperature to 250° C. over a period of 1.5 hours and then from 250° C. to 300° C. over a period of 6 hours and 30 minutes, and then held at 300° C. for 5 hours, thereby causing a pc y erization reaction to proceed in the solid phase to obtain a powdered aromatic liquid crystal polyester.

### <Measurement of Flow Start Temperature of Aromatic Liquid Crystal Polyester>

Using a flow tester (model: CFT-500 manufactured by Shimadzu Corporation) about 2 g of the aromatic liquid crystal polyester was packed in a cylinder equipped with a die having a nozzle with an internal diameter of 1 mm and a length of 10 mm, the aromatic liquid crystal polyester was melted and extruded from the nozzle while the temperature was increased at a rate of 4° C./minute under a loading of 9.8 MPa (100 kg/cm²), and the temperature that yielded a viscosity of 4,800 Pa·s (48,000 poise) was measured.

### <Measurement of Tensile Strength>

Forty parts by mass of milled glass fiber (average fiber length: 75 μm, fiber diameter: 11 μm) was mixed with 60 parts by mass of the powdered aromatic liquid crystal polyester, and the resultant mixture was melt kneaded using a unidirectional twin-screw extruder (PCM-30HS, manufactured by Ikegai, Ltd.), extruded in a strand-like form, cooled, and then cut to obtain a pelletized liquid crystal polyester composition.

The thus obtained liquid crystal polyester composition was molded into an ASTM No. 4 dumbbell shape using an injection molding machine (model: PS40E5ASE, manufactured by Nissei Plastic Industrial Co., Ltd.), and the tensile strength was measured in accordance with ASTM D638.

### <Measurement of Flexural Strength>

Forty parts by mass of milled glass fiber (average fiber length: 75 μm, fiber diameter: 11 μm) was mixed with 60 parts by mass of the powdered aromatic liquid crystal polyester, and the resultant mixture was melt kneaded using a unidirectional twin-screw extruder (PCM-30HS, manufactured by Ikegai, Ltd.), extruded in a strand-like form, cooled, and then cut to obtain a pelletized liquid crystal polyester composition.

The thus obtained liquid crystal polyester composition was molded into a test piece having a length of 127 mm, a width of 12.7 mm and a thickness of 6.4 mm using an injection molding machine (model: PS40E5ASE, manufactured by Nissei Plastic Industrial Co., Ltd.), and the flexural strength was measured in accordance with ASTM D790.

### <Measurement of Deflection Temperature Under Load>

Forty parts by mass of milled glass fiber (average fiber length: 75 μm, fiber diameter: 11 μm) was mixed with 60 parts by mass of the powdered aromatic liquid crystal polyester, and the resultant mixture was melt kneaded using a unidirectional twin-screw extruder (PCM-3OHS, manufactured by Ikegai, Ltd.), extruded in a strand-like form, cooled, and then cut to obtain a pelletized liquid crystal polyester composition.

The thus obtained liquid crystal polyester composition was molded into a test piece having a length of 127 mm, a width of 12.7 mm and a thickness of 6.4 mm using an injection molding machine (model: PS40E5ASE, manufactured by Nissei Plastic Industrial Co., Ltd.), and the deflection temperature under load for the test piece was measured under a load of 1.82 MPa in accordance with ASTM D648.

### <Measurement of Molding Shrinkage Factors>

Forty parts by mass of milled glass fiber was mixed with 60 parts by mass of the powdered aromatic liquid crystal polyester, and the resultant mixture was melt kneaded using a unidirectional twin-screw extruder (PCM-30HS, manufactured by Ikegai, Ltd.), extruded in a strand-like form, cooled, and then cut to obtain a pelletized liquid crystal polyester composition.

Using a flat test piece (hereinafter also referred to as a molded body) of 64 mm (MD)×64 mm (TD)×3 mmt produced from the thus obtained liquid crystal polyester composition using an injection molding machine (model: PS40E5ASE, manufactured by Nissei Plastic Industrial Co., Ltd.), the lengths of the two MD sides were measured, the average value of the two values was determined, and by using this average value and the MD length of the mold cavity, the MD shrinkage was calculated from the formula shown below. Further, for the produced molded body, the lengths of the two TD sides were measured, the average value of the two values was determined, and by using this average value and the TD length of the mold cavity, the TD shrinkage was calculated from the formula shown below.

[MD Shrinkage (%)]=([MD length of mold cavity (μm)]−[average value of two MD sides of molded body (μm)])/[MD length of mold cavity (μm)]×100

[TD Shrinkage (%)]=([TD length of mold cavity (μm)]−[average value of two TD sides of molded body (μm)])/[TD length of mold cavity (μm)]×100

TABLE 1

| | | Compar- | Compar- | Compar- | Compar- | | | | | | |
|---|---|---|---|---|---|---|---|---|---|---|---|
| | | ative | ative | ative | ative | | | | | | |
| | | Exam- | Exam- | Exam- | Exam- | Exam- | Exam- | Exam- | Exam- | Exam- | Exam- |
| | | ple 1 | ple 2 | ple 3 | ple 4 | ple 1 | ple 2 | ple 3 | ple 4 | ple 5 | ple 6 |
| Monomer | 4-hydroxybenzoic acid | 60 | 60 | 60 | | | | | | | |
| compo- | 2-hydroxy-6-naphthoic acid | | | | 60 | 60 | 60 | 60 | 60 | 60 | 60 |
| sition | 4,4′-biphenol | 20 | 18 | 15 | 20 | 19 | 18 | 15 | 19 | 18 | 15 |
| (mol %) | 2,7-dihydroxynaphthalene | | 2 | 5 | | 1 | 2 | 5 | | | |
| | 1,6-dihydroxynaphthalene | | | | | | | | 1 | 2 | 5 |
| | terephthalic acid | 15 | 20 | 20 | 20 | 20 | 20 | 20 | 20 | 20 | 20 |
| | isophthalic acid | 5 | | | | | | | | | |

| Flow start temperature | | ° C. | 330 | 332 | 320 | 337 | 333 | 322 | 297 | 330 | 324 | 323 |
|---|---|---|---|---|---|---|---|---|---|---|---|---|
| Tensile strength | | MPa | 142 | 138 | 150 | 97 | 161 | 182 | 173 | 137 | 146 | 143 |
| Flexural strength | | MPa | 133 | 150 | 166 | 152 | 206 | 199 | 192 | 182 | 185 | 176 |
| Deflection temperature under load | | ° C. | 273 | 272 | 204 | 340 | 325 | 289 | 209 | 311 | 282 | 211 |
| Molding shrinkage | MD | % | 0.22 | 0.12 | 0.20 | 0.15 | 0.19 | 0.15 | 0.11 | 0.09 | 0.16 | 0.17 |
| factors | TD | % | 1.40 | 1.29 | 1.00 | 1.27 | 1.38 | 1.08 | 0.87 | 1.45 | 1.35 | 0.99 |

As is evident from the results shown above in Table 1 compared with Comparitive Examples 1 to 4 that did not apply the present invention, Examples that applied the present invention exhibited superior dimensional stability and had higher strength for the molded articles.

### INDUSTRIAL APPLICABILITY

The present invention can provide an aromatic iquid crystal polyester and an aromatic crystal polyester composition that uses the aromatic liquid crystal polyester which are capable of molding molded articles having excellent dimensional stability and high strength, and is therefore extremely useful industrially.

1. An aromatic liquid crystal polyester containing repeating structural units represented by formulas (A1), (B), (C) and (D) shown below:
—O—Ar1—CO— (A1)
—CO—Ar2—CO— (B)
—O—Ar3—O— (C)
—O—Ar4—O— (D)
wherein
Ar1 represents a 2,6-naphthalenediyl group,
Ar2 represents at least one group selected from the group consisting of a 2,6-naphthalenediyl group, 1,4-phenylene group, 1,3-phenylene group and 4,4′-biphenylene group,
Ar3 represents at least one group selected from the group consisting of a 2,7-naphthalenediyl group, 1,6-naphthalenediyl group and 1,5-naphthalenediyl group,
Ar4 represents at least one group selected from the group consisting of a 2,6-naphthalenediyl group, 1,4-phenylene group, 1,3-phenylene group and 4,4′-biphenylene group, and
each group represented by Ar1, Ar2, Ar3 or Ar4 may have a halogen atom, an alkyl group of 1 to 10 carbon atoms or an aryl group of 6 to 20 carbon atoms as a substituent.

2. The aromatic liquid crystal polyester according to claim 1, composed solely of repeating structural units represented by formulas (A1), (B), (C) and (D).

3. The aromatic liquid crystal polyester according to claim 1, wherein
a molar fraction of the repeating structural unit represented by formula (A1) is at least 30 mol % but not more than 80 mol % relative to a total molar amount of all repeating units,
a molar fraction of the repeating structural unit represented by formula (B) is at least 10 mol % but not more than 35 mol % relative to a total molar amount of all repeating units,
a molar fraction of the repeating structural unit represented by formula (C) is at least 0.1 mol % but not more than 20 mol % relative to a total molar amount of all repeating units, and
a molar fraction of the repeating structural unit represented by formula (D) is at least 9.9 mol % but not more than 34.9 mol % relative to a total molar amount of all repeating units.

4. The aromatic liquid crystal polyester according to claim 1, further containing a repeating structural unit represented by formula (A2) shown below:
—O—Ar1—CO— (A2)
wherein Ar10 represents a 1,4-phenylene group, and the group represented by Ar10 may have a halogen atom, an alkyl group of 1 to 10 carbon atoms or an aryl group of 6 to 20 carbon atoms as a substituent.

5. The aromatic liquid crystal polyester according to claim 1, having a weight average molecular weight of at least 20,000, and a flow start temperature of at least 200° C. but not more than 370° C.

6. The aromatic liquid crystal polyester according to claim 1, wherein the repeating structural unit represented by formula (D) is one or both of a repeating structural unit derived from 4,4′-biphenol and a repeating structural unit derived from hydroquinone.

7. An aromatic liquid crystal polyester composition comprising the aromatic liquid crystal polyester according to claim 1 and glass fiber, wherein
an amount of the glass fiber, relative to a total mass of the aromatic liquid crystal polyester composition, is at least 5% by mass but not more than 60% by mass.

8. A molded article obtained by injection molding of the aromatic liquid crystal polyester according to claim 1.

9. A molded article obtained by injection molding of the aromatic liquid crystal polyester composition according to claim 7.
